(19) United States
(12) Patent Application Publication
(10) Pub. No.: US 2009/0135548 A1
(43) Pub. Date: May 28, 2009

(54) Positive Electrode for Electric Double Layer Capacitors, and Electric Double Layer Capacitors

(75) Inventors: Masaki Yoshio, Saga (JP); Hitoshi Nakamura, Kanagawa (JP); Taiji Nakagawa, Tokushima (JP); Yuichi Katoh, Kanagawa (JP)

Correspondence Address: HARNESS, DICKEY & PIERCE, P.L.C., P.O. BOX 828, BLOOMFIELD HILLS, MI, 48303, US

(73) Assignees: Power System Co., Ltd., Yokohama-shi,Kanagawa (JP); Masaki Yoshio, Saga-shi, Saga (JP)

(21) Appl. No.: 12/224,925

(22) PCT Filed: Mar. 8, 2007
(86) PCT No.: PCT/JP2007/055155

§ 371 Date: Nov. 20, 2008

(30) Foreign Application Priority Data
Mar. 10, 2006 (JP) 2006-066070

(51) Int. Cl. H01G 9/155; C25B 11/12

(52) U.S. Cl. 361/502; 204/294

(57) ABSTRACT

The present invention provides a positive electrode for electric double layer capacitors which can improve basic characteristics, such as energy density, of electric double layer capacitors and also can improve electric double layer capacitors in useful life and stability under high temperatures. Provided is a positive electrode for electric double layer capacitors comprising as electrode active materials a carbonaceous material having a ratio of rhombohedral crystal structure to hexagonal crystal structure in crystal structure of carbon within the range of not less than 20%.

### BACKGROUND OF THE INVENTION

1. Field of the Invention

The present invention relates to a positive electrode for electric double layer capacitors and electric double layer capacitors employing the same.

2. Description of the Related Art

Capacitors can repeat charge and discharge with a big electric current and, therefore, are promising as devices for electric power storage with high charge-and-discharge frequency.

The fact that carbonaceous electrodes are soaked in an organic electrolytic solution to form an electric double layer capacitor is known. Michio Okamura “Electric Double Layer Capacitors and Power Storage Systems” 3rd Edition, The Nikkan Kogyo Shimbun, Ltd., 2005, pages 34 to 37 discloses an electric double layer capacitor comprising a bath partitioned into two sections with a separator, an organic electrolytic solution filled in the bath and two carbonaceous electrodes, one electrode being soaked in one section of the bath and the other electrode being soaked in the other section of the bath. As such carbonaceous electrodes, activated carbon is employed. The organic electrolytic solution is a solution containing a solute dissolved in an organic solvent.

For use as an electrode member, activated carbon is formed in layers by backing with a metal sheet or a metal foil. Electricity is introduced into the bath through the metal sheet or metal foil, and is taken out from the bath. Application of electric current will develop an electrostatic capacitance through polarization of the layer of activated carbon in the bath. A material capable of developing an electrostatic capacitance through its polarization, like activated carbon, is referred to as an electrode active material. A device composed of an electrode active material formed in layer is called a polarizable electrode. A conducting material which supports an electrode active material is referred to as a current collector.

The activated carbon refers to shapeless carbon which has a very large specific surface area because it has innumerable fine pores. In the present specification, shapeless carbon having been synthesized by alkali activation, water vapor activation, or the like and having a BET surface area of about 1000 m²/g or more is referred to as activated carbon.

Japanese Patent Laid-open Publication No. (JP-A) H11(1999)-317333 and JP-A-2002-25867 disclose a nonporous carbonaceous material as an electrode active material for use in electric double layer capacitors. The carbonaceous material comprises fine crystalline carbon similar to graphite and has a specific surface area smaller than that of activated carbon. It is believed that application of voltage to a nonporous carbonaceous material makes ions undergo special adsorption to fine crystalline carbon similar to graphite, resulting in formation of an electric double layer.

JP-A-2005-294780 discloses graphite as an electrode active material for use in power storage elements. This document describes that the researches by the present inventors revealed that electrodes comprising graphite exhibit high withstand voltages and use of such electrodes greatly improves the energy density of electric double layer capacitors. However, although polarizable electrodes have high withstand voltage properties, their effects have been limited due to low capacitances developed.

In particular, in order to put electric double layer capacitors to practical use as auxiliary power sources of electromobiles, power plants and the like, improving fundamental characteristics such as energy density and also improving the useful life and the stability at high temperatures of electric double layer capacitors are demanded.

### SUMMARY OF THE INVENTION

The present invention intends to solve the aforementioned existing problems. The object of the present invention is to provide a positive electrode for electric double layer capacitors which can further improve basic characteristics, such as energy density, of electric double layer capacitors and also can improve useful life and stability under high temperatures.

The present invention provides a positive electrode for electric double layer capacitors comprising as electrode active materials a carbonaceous material having a ratio of rhombohedral crystal structure to hexagonal crystal structure in crystal structure of carbon within the range of not less than 20%. This can achieve the above-mentioned object.

The electric double layer capacitor of the present invention is excellent in basic properties, such as energy density, and excellent also in useful life and stability at high temperatures.

### BRIEF DESCRIPTION OF THE DRAWING

FIG. 1 is an assembling diagram showing the structure of the electric double layer capacitor of the Examples.

### DETAILED DESCRIPTION OF THE PREFERRED EMBODIMENTS

Electric double layer capacitors refer to electric power storage devices which exhibit an electrostatic capacitance due to adsorption of an electrolyte mainly to the tissue of a carbonaceous material used as an electrode active material. For example, since in batteries, electrostatic capacitance is exhibited mainly through intercalation of electrolytes to the tissue of a carbonaceous material, the mechanism of the electrostatic capacitance exhibition differs from adsorption. Therefore, batteries are a different kind of electric power storage devices than electric double layer capacitors. The present inventors can distinguish electric double layer capacitors clearly from batteries. That is, adsorption and intercalation are recognized as being physical phenomena different from each other. It is also possible to know which phenomenon is taking place in an electrode, adsorption or intercalation, by use of a method such as cyclic voltammogram and in-situ X-ray crystal diffraction spectrometry.

Here, to exhibit electrostatic capacitance mainly through adsorption means, for example, to exhibit theoretically about 50% or more, preferably 75% or more, more preferably 85% or more, and even more preferably 90% or more of the electrostatic capacitance in an adsorption mechanism.

A “positive electrode” as used herein refers to a polarizable electrode for use as a positive electrode of an electric double layer capacitor unless otherwise stated. A “negative electrode” refers to a polarizable electrode for use as a negative electrode of an electric double layer capacitor unless otherwise stated.

Activated carbon has heretofore been used as a carbonaceous material for electrode active materials of electric double layer capacitors. The present inventors discovered that one factor of the electrostatic capacitance exhibition in a carbonaceous material is rhombohedral crystal structure of carbon.

Crystal structure of a carbonaceous material mainly includes hexagonal crystal structure and rhombohedral crystal structure. In the hexagonal crystal structure, carbon network faces are in an ABAB-type layered structure in which B layers are dislocated relative to neighboring A layers. On the other hand, a rhombohedral crystal system is a crystal structure having an ABCABC-type layered structure.

For the carbonaceous material for electrode active materials of electric double layer capacitors of the present invention, the more the carbonaceous material rhombohedral contains crystal structure, the better it is. For example, the ratio of the rhombohedral crystal structure to the hexagonal crystal structure in the crystal structure of carbon is 20% or more, e.g. from 25 to 5.00%, from 30 to 300%, from 35 to 250%, from 50 to 200%, from 50 to 180%, from 50 to 175%, from 70 to 200%, from 70 to 180%, from 70 to 175%, from 80 to 180%, from 80 to 175%, from 90 to 180%, from 90 to 175%, from 100 to 180%, from 100 to 175%, from 120 to 180%, and from 120 to 175%.

Nonporous carbon and graphite are preferable as the carbonaceous material of the present invention because graphite is crystalline and nonporous carbon has a graphite-like microcrystalline structure. Henceforth, particularly when graphite and nonporous carbon are called collectively, they are referred to as “graphite family.”

A desirable nonporous carbon is, for example, one disclosed in JP-A-2005-286178, which can be produced in a way described below.

A needle coke green powder is baked under an inert atmosphere, for example, an atmosphere of nitrogen or argon, at 500 to 900° C., preferably 600 to 800° C., and more preferably 650 to 750° C. for 2 to 4 hours. It is conceivable that a crystal structure of carbon tissue is formed during this baking process.

The baked carbon powder is mixed with from 1.8 to 2.2 times, preferably about 2 times, in weight, of alkali hydroxide.

Subsequently, the resulting mixture powder is baked under an inert atmosphere at 650 to 850° C., preferably at 700 to 750° C. for 2 to 4 hours. This step is called alkali activation and is believed to have an effect of relaxing the crystal structure of carbon through permeation of vapor of alkali metal atoms into carbon tissue.

Subsequently, the resulting mixture powder is washed to remove alkali hydroxide. The washing can be conducted, for example, by recovering particles from the carbon after the alkali treatment, filling the articles in a stainless steel column, introducing compressed steam at a temperature of from 120° C. to 150° C. and a pressure of from 10 to 100 kgf, preferably from 10 to 50 kgf into the column, and continuing the introduction of compressed steam until the pH of the waste water becomes 7 or lower (typically 6 to 10 hours). After the completion of the alkali removing step, an inert gas such as argon and nitrogen is allowed to flow in the column for drying. Thus, a desired nonporous carbon powder is obtained.

Graphite desirable for use in the positive electrode for electric double layer capacitors of the present invention may be any one having a crystal lattice constant of a 002 plane, C_{0 (002)}, of from 0.670 to 0.673 nm. The average spacing d₀₀₂ should just be less than 0.337 nm, and preferably of from 0.3352 to 0.3369 nm.

Graphite, which is generally said to have hexagonal crystal structure, is a mixture of hexagonal crystal structure and rhombohedral crystal structure. It is well known that hexagonal crystal structure is converted to rhombohedral crystal structure by pulverization of grinding (see Journal of Chemical Engineering of Japan, 4(6), (1978), 640-645).

For example, when graphite particles are ground under application of shearing force, structure change from hexagonal crystal structure to rhombohedral crystal structure takes place effectively. Examples of desirable means of pulverization include ball mills and jet mills. Pulverization may be continued until the crystal structure changes to a desirable state. On the other hand, rhombohedral crystals are also formed in a process of baking a carbon-containing material, such as resin and coke, under nitrogen flow, etc.

In this specification, the ratio of the hexagonal crystal structure to the rhombohedral crystal structure in the crystal structure of a carbonaceous material, means the ratio of the amount of the hexagonal crystal structure to the amount of the rhombohedral crystal structure in the crystal structure of the carbonaceous material. That is, the ratio of hexagonal crystal structure to rhombohedral crystal structure in crystal structure of carbon, R (%), was determined according to the following formula:

R(%)=(I(101−R)/I(101−H))×100 (1)

wherein I(101−R) is the integrated intensity of the peak(s) assigned to the rhombohedral crystal (101) plane in the X-ray crystal diffraction spectrum and I (101−H) is the integrated intensity of the peak(s) assigned to the hexagonal crystal (101) plane in the X-ray crystal diffraction spectrum.

It is preferable that the graphite be one in which moderate turbulence is generated in a graphite layer and the ratio of a basal plane to an edge plane falls within a certain range. The turbulence of a graphite layer appears, for example, in the result of Raman spectroscopic analysis. Desirable graphite is one having a ratio of the peak intensity at 1360 cm⁻¹ (hereinafter, I(1360)) in a Raman spectroscopic spectrum to the peak intensity at 1580 cm⁻¹ (hereinafter, I(1580)), namely I(1360)/I(1580), of from 0.02 to 0.5, preferably from 0.05 to 0.3, more preferably 0.1 to 0.2, even more preferably about 0.15 (for example, from 0.13 to 0.17).

The shape or dimensions of graphite particles are not particularly limited, if the particles can be formed into a polarizable electrode. For example, flaky graphite particles, consolidated graphite particles, spheroidized graphite particles and needle-shaped graphite may be employed. The properties and preparation methods of such graphite particles are publicly known. In the case of pulverizing graphite particles under application of shearing force, it is preferable, from the viewpoint of improvement in electrode capacitance, to conduct shaping treatment, such as consolidation and spheroidization, after the pulverization.

In general, flaky graphite particles have a thickness of 1 μm or less, desirably 0.1 μm or less, and a maximum particle length of 100 μm or less, desirably 50 μm or less. However, flaky graphite particles which can be used are not restricted to ones having such a thickness or such a particle length. It is possible to produce flaky graphite particles using expanded graphite or the like as a raw material.

The flaky graphite particles can be produced by pulverizing graphite by a special method or flaking and granulating expanded graphite. Examples of the method of the flaking and granulating include a method of pulverizing expanded graphite using supersonic wave and a method of grinding expanded graphite using media. Flaky graphite particles may be subjected to annealing in an inert atmosphere at a temperature of from 2000° C. to 2800° C. for about 0.1 to 10 hours to enhance crystallinity.

Consolidated graphite particles are graphite particles with a high bulk density and generally have a tap density of from 0.7 to 1.3 g/cm³. Consolidated graphite particles include 10% by volume or more of graphite particles in spindle form having an aspect ratio of from 1 to 5, or include 50% by volume or more of graphite particles in disc form having an aspect ratio of from 1 to 10.

Consolidated graphite particles can be produced by consolidating raw material graphite particles. Either natural graphite or synthetic graphite may be used as the raw material graphite particles, but natural graphite is preferred because of its high crystallinity and availability. Graphite may be processed into raw material graphite particles by pulverization of the graphite itself. Alternatively, the aforementioned flaky graphite particles may be used as raw material graphite particles.

Consolidation treatment is conducted by impacting raw material graphite particles. Consolidation treatment using a vibration mill is more preferable particularly because consolidation can be achieved to a high degree. Examples of the vibration mill include vibration ball mills, vibration disc mills and vibration rod mills.

When raw material scaly graphite particles having a high aspect ratio is subjected to consolidation treatment, the raw material graphite particles are converted into secondary particles through their lamination on basal planes of graphite and simultaneously the edges of the secondary particles laminated are rounded to transform into thick discs or spindles. Thus, the raw material graphite particles are converted into graphite particles with a small aspect ratio.

Conversion of graphite particles into those having a small aspect ratio will lead to formation of graphite particles having high crystallinity but having high isotropy and high tap density. Therefore, when the resulting graphite particles are shaped into a polarizable electrode, it is possible to make a graphite slurry have high graphite concentration and the shaped electrode has high graphite density.

In the electric double layer capacitor of the present invention, composite particles composed of cores which are nonporous carbon particles or graphite particles and a carbon covering layer formed on surfaces of the cores, as the carbonaceous material of the positive electrode. The nonporous carbon particles and the graphite particles are referred collectively to as “graphite family particles.” Use of such composite particles for forming a positive electrode of an electric double layer capacitor leads to great improvement in durability at high temperatures. In particular, when carbon of the covering layer is formed by the chemical vapor deposition method (CVD method), the charging/discharging speed is greatly improved.

The carbon covering the surfaces of graphite family particles may be non-crystalline, low-crystalline or crystalline. Materials in which graphite particles are covered with non-crystalline carbon (amorphous carbon) or low-crystalline carbon have been known. Examples of such materials include a composite material produced by covering graphite with low-crystalline carbon by chemical vapor deposition (JP-A-H4 (1992)-368778), a composite material in which graphite is covered with carbon having an average spacing d₀₀₂ of 0.337 nm or more (JP-A-H5 (1993)-121066), and a composite material in which graphite is covered with amorphous carbon (JP-A-H5 (1993)-275076).

However, it is particularly preferable that the carbon which covers graphite family particles be crystalline because this results in an advantage that the rate of adsorption-and-desorption of ions increases. As the method for covering the surface of graphite family particles with crystalline carbon, chemical vapor deposition using a fluidized bed-type reactor is excellent. Examples of the organic substance to be used as the carbon source for the chemical vapor deposition include aromatic hydrocarbons such as benzene, toluene, xylene and styrene and aliphatic hydrocarbons such as methane, ethane and propane.

Such organic substances are introduced into a fluidized bed reactor as their mixtures with inert gas such as nitrogen. The concentration of the organic substance in the mixed gas is preferably from 2 to 50 mol % and more preferably from 5 to 33 mol %. The chemical vapor deposition treatment temperature is preferably from 850 to 1200° C., and more preferably from 950 to 1150° C. When chemical vapor deposition treatment is conducted under such conditions, the surface of a graphite particle can be covered with an AB plane (namely, a basal plane) of crystalline carbon uniformly and completely.

The amount of carbon necessary for forming the cover layer in terms of the percentage of the amount of the covering carbon based on the entire amount of the composite material, which may vary depending on the size and shape of graphite particles, is preferably from 1 to 15% by mass, and more preferably from 2 to 10% by mass. When the amount is less than 1% by mass, the effect of the covering is not obtained. Conversely, when the covering carbon is too much, the rate of graphite is too small and, therefore, disadvantages, such as declination of charge-and-discharge capacity, are caused. In addition, the production cost is increased.

Composite particles composed of graphite family particles covered with a covering layer of carbon may be produced by coating cores like graphite family particles with resin and then carbonizing the coated resin. Resin suitable for coating graphite family particles is a resin which can provide a high carbonization yield and examples of such resin include resorcinol resin and furfuryl alcohol resin.

The coating with resin can be conducted by preparing a solution by dissolving the resin in a suitable solvent, immersing core carbon particles in the solution, and drying the particles. The carbonization of the resin with which the core carbon particles have been coated can be done by baking the coated particles. The baking is carried out generally in an inert atmosphere at a temperature within the range of from 300° C. to 2000° C., preferably from 500° C. to 1000° C., for a period of time from 0.5 to 10 hours, preferably from 1.0 to 2.0 hours.

A positive electrode including graphite family particles or composite particles composed of graphite family particles coated with a covering layer of carbon can be prepared by a method similar to conventional methods using graphite family particles as a carbonaceous material. Henceforth, the term “graphite family particles” encompasses “graphite family-carbon composite particles” unless otherwise stated. For example, sheet-form polarizable electrodes are produced by regulating the particle size of the aforementioned graphite family particles, subsequently adding an electrically-conductive aid, such as carbon black, for imparting electrical conductivity to the graphite family particles, and a binder, such as polyvinylidene fluoride (PVDF), kneading the mixture, and shaping the kneaded material into a sheet-form by rolling.

Besides carbon black, acetylene black or the like may be used as an electrically-conductive aid. Examples of available binder besides PVDF include polymers such as PTFE, PR, PP, NBR and SBR, and an emulsion of acrylic polymers. The mixing ratio of the nonporous carbon to the electrically-conductive aid (carbon black) to the binder (PVDF) is generally about 10 to 1/0.5 to 10/0.5 to 0.25.

The resulting sheet-form polarizable electrode is joined to a current collector, yielding an electrode member. As the current collector, a material is used which has a form usually used for electric double layer capacitors. The form of the current collector may be a sheet form, a prismatic form, a cylindrical form, and the like. A particularly preferable form is sheet or foil. The material of the current collector may be aluminum, copper, silver, nickel, titanium, and the like.

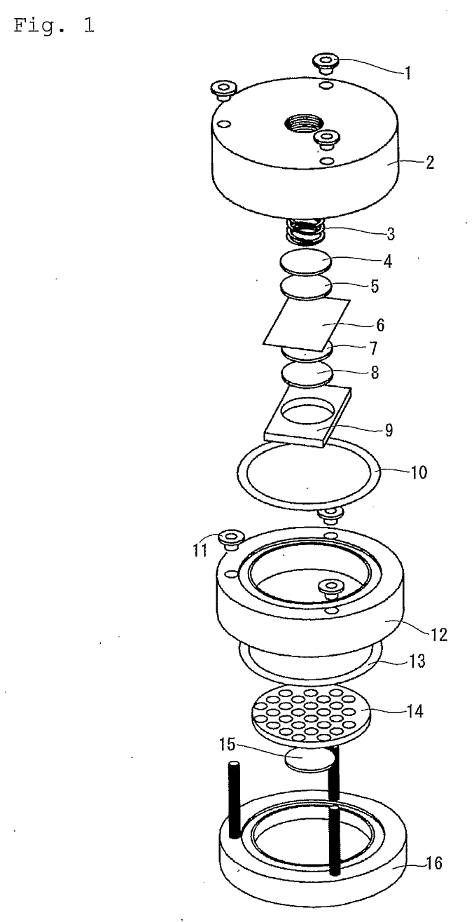

The polarizable electrode or electrode member prepared can be used as a positive electrode of an electric double layer capacitor having a structure conventionally known. Structures of electric double layer capacitors are shown, for example, in FIGS. 5 and 6 of JP-A-H11(1999)-317333, FIG. 6 of JP-A-2002-25867, and FIGS. 1 to 4 of JP-A-2000-77273. Generally, such an electric double layer capacitor can be assembled by superposing electrode members via a separator to form a positive and negative electrodes, and then impregnating the electrodes with an electrolytic solution.

Separators are materials which meet standards regarding insulation conductance, oxidation resistance, heat resistance, stability and holding ability for an electrolytic solution. Desirable materials are porous films or nonwoven fabrics containing a resin selected from the group consisting of polytetrafluoroethylene, polyethylene, polypropylene, polyethylene terephthalate and polyamide. Among these materials, polyolefin resins such as polytetrafluoroethylene, polyethylene and polypropylene are preferred because of their excellent stabilities.

Examples of desirable porous films include polytetrafluoroethylene membrane and porous polypropylene. Examples of nonwoven fabrics include ones formed of polypropylene fibers, polyethylene terephthalate fibers, polyamide fibers, aromatic polyamide fibers, polyethylene fibers, mixtures thereof, e.g. a mixture of polyester fibers and aromatic polyamide fibers. Among such nonwoven fabrics, one which is particularly desirable as a separator is PTFE membrane. Materials containing cellulose, for example, paper-based materials, are not suitable as the separator in the capacitor system of the present invention because the durability is not improved under a high-temperature environment where electric double layer capacitors are used. Hence, use of materials composed of cellulose-based separators impregnated with resin, ceramic or the like is recommended.

The negative electrode may be any polarizable electrode. For example, a carbonaceous negative electrode containing a carbonaceous material the same that forming the positive electrode, like graphite family particles. As a negative-electrode, electrodes which have conventionally been used for electric double layer capacitors may otherwise be used. In such cases, for example, an electrode member for a negative electrode can be produced by forming a polarizable electrode in a manner similar to that mentioned above except for using activated carbon particles or the like instead of the graphite particles, followed by joining the polarizable electrode to a current collector.

Composite particles composed of activated carbon particle cores coated with a covering layer of carbon may be used as the carbonaceous material of the negative electrode. Use of such composite particles for forming a negative electrode of an electric double layer capacitor leads to great improvement in durability at high temperatures. In particular, when carbon of the covering layer is formed by the CVD method, the charging/discharging speed will be greatly improved. Composite particles having activated carbon particles as cores can be produced in a manner the same as that of the production of composite particles having graphite family particles as cores.

As the electrolytic solution, a so-called organic electrolytic solution prepared by dissolving an electrolyte as a solute in an organic solvent may be used. As the electrolyte, substances which are usually used by persons skilled in the art, such as those disclosed in JP-A-2005-294780 may be used. Specific examples include salts with tetrafluoroboric acid or hexafluoroboric acid, of lower aliphatic quaternary ammonium such as triethylmethyl ammonium (TEMA), tetraethylammonium (TEA) and tetrabutylammonium (TBA); lower aliphatic quaternary phosphonium such as tetraethylphosphonium (TEP); or imidazolium derivatives, such as 1-ethyl-3-methylimidazolium (EMI).

Particularly preferable electrolyte are salts of pyrrolidinium compounds and their derivatives. Preferable pyrrolidinium compound salts have a structure shown by the formula:

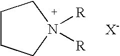

wherein R is each independently an alkyl group or R and R form together an alkylene group, and X⁻ is a counter anion. Pyrrolidinium compound salts are conventionally known and any one prepared by a method known to those skilled in the art may be used.

Preferable ammonium components in the pyrrolidinium compound salts are those wherein in the formula given above R is each independently an alkyl group having from 1 to 10 carbon atoms or R and R form together an alkylene group having from 3 to 8 carbon atoms. More preferable are a compound wherein R and R form together an alkylene group having 4 carbon atoms (namely, spirobipyrrolidinium) and a compound wherein R and R form together an alkylene group having 5 carbon atoms (namely, piperidine-1-spiro-1′-pyrrolidinium). Use of such compounds leads to an advantage that the decomposition voltage has a wide potential window and they are dissolved in a large amount in a solvent. The alkylene groups may have substituents.

The counter anion X⁻ may be any one which has heretofore been used as an electrolyte ion of an organic electrolytic solution. Examples include a tetrafluoroborate anion, a fluoroborate anion, a borate anion partly substituted with a borofluoroalkyl group, a fluorophosphate anion, a hexafluorophosphate anion, a perchlorate anion, a borodisalicylate anion and a borodioxalate anion. Preferable counter anions are a tetrafluoroborate anion and a hexafluorophosphate anion.

When the aforesaid electrolyte is dissolved in an organic solvent as a solute, an organic electrolytic solution for electric double layer capacitors is obtained. The concentration of an electrolyte in an organic electrolytic solution is controlled to from 0.8 to 3.5 mol % and preferably from 1.0 to 2.5 mol %. If the concentration of the electrolyte is less than 0.8 mol %, the number of ions contained is not sufficient and enough capacitance may not be produced. A concentration over 2.5 mol % is meaningless because it does not contribute to capacitance. Electrolytes may be used alone or as mixtures of two or more kinds of them. Such electrolytes may be used together with electrolytes conventionally employed for organic electrolytic solutions.

As the organic solvent, ones which have heretofore been used for organic electric double layer capacitors may be used. For example, ethylene carbonate (EC), propylene carbonate (PC), gamma-butyrolactone (GBL) and sulfolane (SL) are preferable because of their high dissolvability of electrolytes and their high safety. Solvents including these as main solvent and at least one auxiliary solvent selected from dimethyl carbonate (DMC), ethylmethyl carbonate (EMC) and diethyl carbonate (DEC) are also useful because the low-temperature characteristics of electric double layer capacitors are improved. Use of acetonitrile (AC) as an organic solvent is preferable from the viewpoint of conductances because it improves conductivity of electrolytic solutions. However, in some cases, applications are restricted.

The present invention will be described in more detail below with reference to Examples, but the invention is not limited thereto. Note that the amounts expressed in “part(s)” or “%” in the Examples are by weight unless otherwise stated.

### EXAMPLES

### Preparation of Graphite Family Particles

Graphite particles 1 are flaky graphite particles prepared by grinding graphite with media so that it came to have an average particle diameter of about 5 μm.

Graphite particles 2 to 5 are each particles prepared by further grinding graphite 1 so that the percentage of rhombohedral crystals was controlled as shown in Table 3.

Graphite particles 6 to 10 are each artificial graphite such that the percentage of rhombohedral crystals was controlled as shown in Table 3.

Nonporous carbon particles 1 and 2 were each a product prepared by baking needle coke at 900° C. under nitrogen flow, kneading it with the same amount of KOH, then baking again at 650° C., and thereafter grinding the resultant so that the average particle diameter became about 5 μm.

Analysis of Graphite Family Particles

### (1) X-Ray Crystallographic Analysis

Graphite particles were measured by means of an X-ray diffraction analyzer (“RINT-UltimaIII” manufactured by Rigaku Corp.).

Through analysis of the resulting X-ray diffraction spectrum, a crystal lattice constant of the (002) plane (C₀₍₀₀₂₎), an average spacing d₀₀₂ (Angstrom) and a half width of a (002) peak (a peak near 2θ=26.5°) were determined. The measurement was conducted at 40 kV, 50 mA using CuKalpha as a target.

The peak position of a rhombohedral crystal (101−R) was present near 2θ=43.3° and the integration intensity thereof was indicated by I(101−R). The peak position of a hexagonal crystal (101−H) was present near 2θ=44.5° and the integration intensity was indicated by I(101−H). The ratio, R (%), of the rhombohedral crystal structure to the hexagonal crystal structure, both the structures being present in the crystal structure, was determined according to formula (1).

TABLE 1

| | | | | | Amount of |
|---|---|---|---|---|---|
| | 002 | 101 | 101 | | rhombohedral |
| | Plane | Plane | Plane | | crystal graphite |
| Sample | (Å) | (H) | (R) | R/H | (%) |
| Graphite 1 | 3.366 | 559 | 324 | 0.58 | 58 |
| Graphite 2 | 3.356 | 238 | 238 | 1.00 | 100 |
| Graphite 3 | 3.353 | 203 | 196 | 0.97 | 97 |
| Graphite 4 | 3.353 | 188 | 213 | 1.13 | 113 |
| Graphite 5 | 3.366 | 295 | 342 | 1.16 | 116 |
| Graphite 6 | 3.373 | 207 | 357 | 1.72 | 172 |
| Graphite 7 | 3.361 | 297 | 371 | 1.25 | 125 |
| Graphite 8 | 3.366 | 467 | 392 | 0.84 | 84 |
| Graphite 9 | 3.354 | 1351 | 446 | 0.33 | 33 |
| Graphite | 3.355 | 1573 | 409 | 0.26 | 26 |
| 10 | | | | | |
| Nonporous | 3.453 | 191 | 187 | 0.98 | 98 |
| carbon 1 | | | | | |
| Nonporous | 3.455 | 183 | 171 | 0.93 | 93 |
| carbon 2 | | | | | |

### (2) Raman Spectroscopic Analysis

Graphite particles were measured by using a Raman spectrometer (“laser Raman spectrometer NRS-3100” manufactured by JASCO Corp.) under the following conditions.

TABLE 2

| | |
|---|---|
| Exposure time | 1 s |
| The number of integration | 20 |
| Central wavenumber | 1500 cm⁻¹ |
| Slit | 1 * 6 mm |
| Beam attenuator | Open |
| Objective lens | 100x |
| Excitation wavelength | 532.080 cm⁻¹ |
| Grating | 1800 1/mm |

In the resulting Raman spectroscopic spectrum, a ratio of the peak intensity at 1360 cm⁻¹ (D band) to the peak intensity at 1580 cm⁻¹ (G band), 1(1360)/I(1580), was determined.

TABLE 3

| | | G | D | (D-BL)/(G- |
|---|---|---|---|---|
| Sample | BaseLine | (I1580) | (I1360) | BL) |
| Graphite 1 | 140.1 | 161.5 | 142.7 | 0.12 |
| Graphite 2 | 201.0 | 249.0 | 215.6 | 0.30 |
| Graphite 3 | 155.5 | 206.8 | 182.0 | 0.52 |
| Graphite 4 | 115.4 | 237.8 | 191.0 | 0.62 |
| Graphite 5 | 197.2 | 218.6 | 210.0 | 0.60 |
| Graphite 6 | 201.0 | 218.8 | 216.1 | 0.85 |
| Graphite 7 | 199.3 | 217.2 | 212.7 | 0.75 |
| Graphite 8 | 212.1 | 249.0 | 225.1 | 0.35 |
| Graphite 9 | 147.6 | 193.5 | 158.6 | 0.24 |
| Graphite 10 | 105.1 | 153.9 | 114.0 | 0.18 |
| Nonporous carbon 1 | 124.8 | 128.8 | 127.0 | 0.54 |
| Nonporous carbon 2 | 127.7 | 128.9 | 128.0 | 0.25 |

Preparation of Composite Particles

### (1) Graphite Composite Particles

A) CVD treatment: Graphite particles 5 are placed in a quartz cuvette put in an oven heated to a temperature range from 900 to 1100° C. Benzene vapor is introduced into the cuvette using argon as a carrier gas, so that xylene was carbonized on the graphite by deposition carbonization. This treatment was repeated while the amount of carbon deposited was changed.

B) Resin coating treatment 1: A solution of bakelite resin (trade name: Resitop, produced by Gunei Chemical Industry Co., Ltd.) was controlled to various concentrations. Then, separate portions of graphite particles 5 were dipped in these solutions and dried. Each of the portions was baked at 600° C. in nitrogen flow, so that the resin was carbonized.

C) Resin coating treatment 2: A solution of xylene-soluble coal pitch (produced by Nippon Steel Chemical Co., Ltd.) was adjusted to various concentrations with a solvent. Then, graphite particles 5 were dipped in these solutions and dried. Each of the portions was baked at 600° C. in nitrogen flow, so that the resin was carbonized.

### (2) Nonporous Carbon Composite Particles

A) CVD treatment was conducted in the same manner as in the case of graphite-carbon composite particles except for using nonporous carbon particles 1 instead of graphite particles 5.

### (3) Activated Carbon Composite Particles

A) CVD treatment was conducted in the same manner as in the case of graphite-carbon composite particles except for using activated carbon particles 1 instead of graphite particles 5.

### Example 1

### (1) Preparation of Carbon Electrode

3 g of carbon particles 1, 1 g of acetylene black (manufactured by DENKI KAGAKU KOGYO KABUSHIKI KAISHA) and 0.3 g of polytetrafluoroethylene powder (manufactured by Mitsui duPont Fluorochemical Co., Ltd.) were mixed and kneaded in an agate mortar. The kneaded matter was shaped into a sheet having a uniform thickness of 0.4 mm by use of a molding machine, yielding a positive electrode.

### (2) Production of Electric Double Layer Capacitor

Appropriate amounts of activated carbon (“MSP20” manufactured by THE KANSAI COKE AND CHEMICALS Co., Ltd.), acetylene black (manufactured by DENKI KAGAKU KOGYO KABUSHIKI KAISHA), and a solution of polyvinylidene fluoride (PVDF) in n-methylpyrrolidone (manufactured by KUREHA CORPORATION) were mixed and kneaded in an agate mortar. The kneaded matter was shaped into a sheet having a uniform thickness of 0.4 mm by use of a molding machine, yielding a negative electrode.

A disc with a diameter of 20 mm was punched out of each of the resulting carbon sheets and then was used to fabricate a three-electrode cell as shown in FIG. 1. Aluminum foil was used as a current collector and the aforementioned polytetrafluoroethylene (PTFE) membrane was used as a separator. A sheet prepared by sheeting activated carbon #1711 in a manner similar to those mentioned above was used as a reference electrode. The cell was dried in a vacuum at 140° C. for 24 hours, and then cooled. An electrolytic solution was prepared by dissolving spirobipyrrolidinium hexafluorophosphorus (SBPPF₆) into propylene carbonate to a concentration of 2.0 mol %. The resulting electrolytic solution was poured into the cell to produce an electric double layer capacitor.

### (3) Performance Test

A charge-and-discharge tester “CDT-RD20” manufactured by Power Systems Co., Ltd. was connected to the electric double layer capacitor assembled and constant-current charging at 5 mA was conducted for 7200 seconds. After arrival at a prescribed voltage, constant-current discharging at 5 mA was conducted. Using a preset voltage of 3.5 V, three cycles of operation was carried out and the data of the third cycle were adopted. The capacitance (mAh/g) per unit weight of the positive electrode active material was calculated from the discharged power. The results are shown in Table 4.

### Examples 2 to 10

Electric double layer capacitors were prepared and examined in a manner the same as Example 1 except for using graphite particles 2 to 10 instead of graphite particles 1 as the carbonaceous material of the positive electrode. The test results are shown in Table 4.

### Examples 11 to 14

Positive electrodes were prepared and examined in a manner the same as Example 1 except for using graphite particles 2, 5 and nonporous carbon 1 and 2 instead of graphite particles 1 as the carbonaceous material of the positive electrode. Likewise, negative electrodes were also produced. Electric double layer capacitors were produced and examined in a manner the same as Example 1 except for using the positive and negative electrodes produced. The test results are shown in Table 4.

TABLE 4

| | Positive | | |
|---|---|---|---|
| | electrode | Negative | Capacitance |
| Examples | (Rhom. %) | electrode | (mAh/g) |
| 1 | Graphite 1 | Activated | 48 |
| | (58) | carbon | |
| 2 | Graphite 2 | Activated | 56 |
| | (100) | carbon | |
| 3 | Graphite 3 | Activated | 54 |
| | (97) | carbon | |
| 4 | Graphite 4 | Activated | 64 |
| | (113) | carbon | |
| 5 | Graphite 5 | Activated | 65 |
| | (116) | carbon | |
| 6 | Graphite 6 | Activated | 113 |
| | (172) | carbon | |
| 7 | Graphite 7 | Activated | 70 |
| | (125) | carbon | |
| 8 | Graphite 8 | Activated | 47 |
| | (84) | carbon | |
| 9 | Graphite 9 | Activated | 21 |
| | (33) | carbon | |
| 10 | Graphite 10 | Activated | 16 |
| | (26) | carbon | |
| 11 | Graphite 5 | Graphite 5 | 79 |
| | (116) | | |
| 12 | Graphite 6 | Graphite 6 | 126 |
| | (172) | | |
| 13 | Nonporous | Nonporous | 55 |
| | carbon 1 | carbon 1 | |
| | (98) | | |
| 14 | Nonporous | Nonporous | 53 |
| | carbon 2 | carbon 2 | |
| | (93) | | |

### Examples 15 to 21

Electric double layer capacitors were prepared and examined in a manner the same as Example 1 except for using carbon composite particles shown in Table 5 as the carbonaceous material of the positive electrode and changing the kinds of the carbonaceous material of the negative electrode and the electrolytic solution to those shown in Table 5. Then, the capacitances were calculated.

Subsequently, the ambient temperature was raised up to 60° C. and 1000 cycles of charging/discharging were conducted under conditions the same as those in Example 1. Thereafter, the capacitance retentions (%) were measured. These test results are shown in Table 5.

TABLE 5

| | | Negative | | | |
|---|---|---|---|---|---|
| | | electrode | | | |
| | Positive electrode | treatment | | Initial | Capacitance |
| | treatment (coating amount | (coating | | capacitance | retention |
| | in wt %) | amount in wt %) | Electrolyte | (mAh/g) | (%) |
| Example 15 | Graphite 5 CVD (0) | Activated | SBPPF₆ | 75 | 51 |
| | | carbon | | | |
| | Graphite 5 CVD (2) | Activated | SBPPF₆ | 78 | 55 |
| | | carbon | | | |
| | Graphite 5 CVD (4) | Activated | SBPPF₆ | 78 | 62 |
| | | carbon | | | |
| | Graphite 5 CVD (8) | Activated | SBPPF₆ | 77 | 81 |
| | | carbon | | | |
| | Graphite 5 CVD (16) | Activated | SBPPF₆ | 76 | 88 |
| | | carbon | | | |
| | Graphite 5 CVD (32) | Activated | SBPPF₆ | 75 | 94 |
| | | carbon | | | |
| Example 16 | Graphite 5 resin coating | Activated | SBPPF₆ | 76 | 52 |
| | 1 (0) | carbon | | | |
| | Graphite 5 resin coating | Activated | SBPPF₆ | 70 | 55 |
| | 1 (2) | carbon | | | |
| | Graphite 5 resin coating | Activated | SBPPF₆ | 68 | 61 |
| | 1 (4) | carbon | | | |
| | Graphite 5 resin coating | Activated | SBPPF₆ | 64 | 79 |
| | 1 (8) | carbon | | | |
| | Graphite 5 resin coating | Activated | SBPPF₆ | 59 | 86 |
| | 1 (16) | carbon | | | |
| | Graphite 5 resin coating | Activated | SBPPF₆ | 51 | 91 |
| | 1 (32) | carbon | | | |
| Example 17 | Graphite 5 resin | Activated carbon | SBPPF₆ | 75 | 51 |
| | coating 2 (0) | | | | |
| | Graphite 5 resin | Activated carbon | SBPPF₆ | 71 | 54 |
| | coating 2 (2) | | | | |
| | Graphite 5 resin | Activated carbon | SBPPF₆ | 69 | 59 |
| | coating 2 (4) | | | | |
| | Graphite 5 resin | Activated carbon | SBPPF₆ | 66 | 71 |
| | coating 2 (8) | | | | |
| | Graphite 5 resin | Activated carbon | SBPPF₆ | 61 | 82 |
| | coating 2 (16) | | | | |
| | Graphite 5 resin | Activated carbon | SBPPF₆ | 57 | 88 |
| | coating 2 (32) | | | | |
| Example 18 | Carbon 1 CVD (0) | Activated carbon | SBPPF₆ | 49 | 69 |
| | Carbon 1 CVD (2) | Activated carbon | SBPPF₆ | 55 | 77 |
| | Carbon 1 CVD (4) | Activated carbon | SBPPF₆ | 56 | 83 |
| | Carbon 1 CVD (8) | Activated carbon | SBPPF₆ | 54 | 89 |
| | Carbon 1 CVD (16) | Activated carbon | SBPPF₆ | 53 | 93 |
| | Carbon 1 CVD (32) | Activated carbon | SBPPF₆ | 51 | 98 |
| Example 19 | Graphite 5 CVD (10) | Activated | SBPPF₆ | 76 | 52 |
| | | carbon CVD (0) | | | |
| | Graphite 5 CVD (10) | Activated | SBPPF₆ | 71 | 66 |
| | | carbon CVD (2) | | | |
| | Graphite 5 CVD (10) | Activated | SBPPF₆ | 66 | 96 |
| | | carbon CVD (4) | | | |
| | Graphite 5 CVD (10) | Activated | SBPPF₆ | 62 | 98 |
| | | carbon CVD (8) | | | |
| | Graphite 5 CVD (10) | Activated | SBPPF₆ | 51 | 99 |
| | | carbon CVD | | | |
| | | (16) | | | |
| | Graphite 5 CVD (10) | Activated | SBPPF₆ | 23 | 99 |
| | | carbon CVD | | | |
| | | (32) | | | |
| Example 20 | Graphite 5 CVD (0) | Activated carbon | EMIPF₆ | 59 | 41 |
| | Graphite 5 CVD (2) | Activated carbon | EMIPF₆ | 63 | 52 |
| | Graphite 5 CVD (4) | Activated carbon | EMIPF₆ | 68 | 66 |
| | Graphite 5 CVD (8) | Activated carbon | EMIPF₆ | 69 | 71 |
| | Graphite 5 CVD (16) | Activated carbon | EMIPF₆ | 71 | 70 |
| | Graphite 5 CVD (32) | Activated carbon | EMIPF₆ | 70 | 69 |
| Example 21 | Graphite 5 CVD (0) | Activated carbon | TEMAPF₆ | 66 | 37 |
| | Graphite 5 CVD (2) | Activated carbon | TEMAPF₆ | 71 | 48 |
| | Graphite 5 CVD (4) | Activated carbon | TEMAPF₆ | 77 | 59 |
| | Graphite 5 CVD (8) | Activated carbon | TEMAPF₆ | 75 | 65 |
| | Graphite 5 CVD (16) | Activated carbon | TEMAPF₆ | 80 | 65 |
| | Graphite 5 CVD (32) | Activated carbon | TEMAPF₆ | 77 | 63 |

Carbon 1: Nonporous carbon 1
SBPPF₆: Solution of spirobipyridinium hexafluorophosphate in propylene carbonate (2.0 mol %)
EMIPF₆: Solution of ethylmethylimidazolium hexafluorophosphate in propylene carbonate (2.0 mol %)
TEMAPF₆: Solution of triethylmethylammonium hexafluorophosphate in propylene carbonate (2.0 mol %)

According to the results of the Examples, electric double layer capacitors having a positive electrode made of a carbonaceous material in which the ratio of rhombohedral crystal structure to hexagonal crystal structure in crystal structure is 20% or more are excellent in basic characteristics such as energy density. The carbonaceous material coated with the CVD method or the like further provided stable cycle characteristics.

1. A positive electrode for electric double layer capacitors comprising as electrode active materials a carbonaceous material having a ratio of rhombohedral crystal structure to hexagonal crystal structure in crystal structure of carbon within the range of not less than 20%.

2. The positive electrode for electric double layer capacitors according to claim 1, wherein the carbonaceous material has a ratio of rhombohedral crystal structure to hexagonal crystal structure in crystal structure of carbon within the range of from 90 to 180%.

3. The positive electrode for electric double layer capacitors according to claim 1, wherein the carbonaceous material is made of graphite or nonporous carbon.

4. The positive electrode for electric double layer capacitors according to claim 3, wherein the graphite has an I(1360)/I(1580) ratio determined by Raman spectroscopy within the range of from 0.15 to 1.2.

5. An electric double layer capacitor comprising, the positive electrode according to claim 1 and a carbonaceous negative electrode, immersed in an electrolytic solution obtained by making a solute dissolved in a nonaqueous solvent.

6. The electric double layer capacitor according to claim 5, wherein the carbonaceous negative electrode comprises as electrode active materials a carbonaceous material having a ratio of rhombohedral crystal structure to hexagonal crystal structure in crystal structure of carbon within the range of not less than 20%.

7. The electric double layer capacitor according to claim 6, wherein the carbonaceous material is graphite or nonporous carbon.

8. The electric double layer capacitor according to claim 7, wherein the graphite has an I(1360)/I(1580) ratio determined by Raman spectroscopy within the range of from 0.15 to 1.2.

9. The electric double layer capacitor according to claim 5, wherein the carbonaceous negative electrode comprises activated carbon as electrode active materials.

10. The electric double layer capacitor according to claim 5, wherein the solute is at least one electrolyte selected from the group consisting of tetrafluoroborates of quaternary ammonium and derivatives thereof and hexafluorophosphates of quaternary ammonium and derivative thereof.

11. The electric double layer capacitor according to claim 5, wherein the solute is a pyrrolidinium compound salt having a structure represented by the following formula: 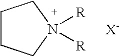
wherein R is each independently an alkyl group or R and R form together an alkylene group, and X⁻ is a tetrafluoroborate anion or a hexafluorophosphate anion.

12. A positive electrode for electric double layer capacitors comprising carbon composite particles which are composed of a graphite family particle having a ratio of rhombohedral crystal structure to hexagonal crystal structure in crystal structure of carbon within the range of not less than 20% and a carbon layer covering the graphite family particle.

13. The positive electrode for electric double layer capacitors according to claim 12, wherein the graphite family particles have a ratio of rhombohedral crystal structure to hexagonal crystal structure in crystal structure of carbon within the range of from 90 to 180%.

14. The positive electrode for electric double layer capacitors according to claim 12, wherein the graphite family particle is made of graphite or nonporous carbon.

15. The positive electrode for electric double layer capacitors according to claim 14, wherein the graphite has an I(1360)/I(1580) ratio determined by Raman spectroscopy within the range of from 0.15 to 1.2.

16. An electric double layer capacitor comprising, the positive electrode according to claim 12 and a carbonaceous negative electrode, immersed in an electrolytic solution obtained by making a solute dissolved in a nonaqueous solvent.

17. The electric double layer capacitor according to claim 16, wherein the carbonaceous negative electrode comprises as electrode active materials a carbonaceous material having a ratio of rhombohedral crystal structure to hexagonal crystal structure in crystal structure of carbon within the range of not less than 20%.

18. The electric double layer capacitor according to claim 17, wherein the carbonaceous material is graphite or nonporous carbon.

19. The electric double layer capacitor according to claim 16, wherein the carbonaceous negative electrode comprises activated carbon as electrode active materials.

20. The electric double layer capacitor according to claim 16, wherein the carbonaceous negative electrode comprises as electrode active materials carbon composite particles which are composed of an activated carbon particle and a carbon layer covering the activated carbon particle.
